(19) United States
(12) Patent Application Publication
(10) Pub. No.: US 2011/0123877 A1
(43) Pub. Date: May 26, 2011

(54) CATALYST FOR OXYGEN REDUCTION ELECTRODE AND OXYGEN REDUCTION ELECTRODE

(75) Inventors: Masashi Matsumoto, Minato-ku (JP); Hideto Imai, Minato-ku (JP); Yasuharu Okamoto, Minato-ku (JP); Tetsuaki Hirayama, Minato-ku (JP); Masahiro Suguro, Minato-ku (JP); Sadanori Kuroshima, Minato-ku (JP); Takashi Manako, Minato-ku (JP)

(73) Assignee: NEC CORPORATION, Minato-ku, Tokyo (JP)

(21) Appl. No.: 12/674,328

(22) PCT Filed: Aug. 5, 2008
(86) PCT No.: PCT/JP2008/064060

§ 371 Date: Feb. 19, 2010

(30) Foreign Application Priority Data
Aug. 23, 2007 (JP) 2007-217228

(51) Int. Cl. H01M 4/86; B01J 31/12; C08G 73/06; H01M 4/60

(52) U.S. Cl. 429/405; 502/159; 502/1; 525/417; 429/531

(57) ABSTRACT

An oxygen reduction catalyst and the catalyst as an electrode catalyst are provided. The oxygen reduction catalyst is characterized by including an organometallic polymer structure in which a transition metal or zinc is coordinated with an organic polymer compound including a ligand comprising a heterocyclic 5-membered ring or a heterocyclic 6-membered ring containing at least not less than two elements selected from nitrogen (N), oxygen (O), sulfur (S), and selenium (Se), and derivatives thereof. Thereby, even when an amount of a metal is smaller than that in a platinum particulate catalyst, an oxygen reduction capacity equal to or more than that of the platinum particulate catalyst can be obtained. Further, by coordinating a metal with an organic polymer, stability in an oxygen reduction condition can be significantly improved compared to the case of metal based macrocyclic compounds.

### TECHNICAL FIELD

The present invention relates to a catalyst that accelerates an oxygen reduction reaction in an aqueous solution, and particularly relates to a catalyst used for electrodes of electrochemical devices such as fuel cells and air cells, a structure of the electrode catalyst, a configuration thereof, and a method for manufacturing a catalyst.

### BACKGROUND ART

Fuel cells and air cells are electrochemical energy devices that use oxygen in the air as an oxidizer to extract chemical reaction energy obtained by reaction with compounds or negative electrode active materials serving as a fuel in a form of electrical energy. The fuel cells and air cells have a theoretical energy capacity higher than that of secondary cells such as Li ion batteries, and can be used as a power supply mounted on automobiles, a fixed type distributed power supply for home and factories, and a power supply for portable electronic apparatuses. An electrochemical reaction occurs on an oxygen pole side of the fuel cell or air cell so that oxygen is reduced. The oxygen reduction reaction is a reaction that is unlikely to progress at a comparatively lower temperature, and is one of principal factors that reduce energy conversion efficiency in the fuel cells and the air cells.

A catalyst mainly used for an oxygen reduction catalyst is one that carries platinum (Pt) having an average particle diameter of a nano metric size or an alloy of Pt on a support such as carbon black having a larger specific surface. Among known catalysts, Pt shows a comparatively higher oxygen reduction activity to the electrochemical reaction that reduces oxygen to water. However, practically, such an oxygen reduction activity of Pt is still insufficient. In order to use the fuel cells and the air cells as a power supply for the above-mentioned application, a large amount of Pt is needed. Pt is rare and expensive, and use of a large amount of Pt as an electrode catalyst practically poses a problem of cost. Therefore, a great technical task is development of a catalyst by increasing the specific surface of platinum by further miniaturization, reducing the amount of platinum by alloying while increasing the catalytic activity, or using no platinum.

As a catalyst in which no platinum is used, metal based macrocyclic compounds have been known in which a metal in an atom or ion form is coordinated with an organic skeleton of phthalocyanine or porphyrin, for example (Non-Patent Document 1). Even comparatively inexpensive metals other than platinum can be coordinated, and reduction in an amount of a metal is also expected compared with a case where a metal particulate catalyst is used. However, most of the metal based macrocyclic compounds show the catalytic activity considerably lower than that of Pt. Further, the metal based macrocyclic compounds are very unstable in an acidic solution, and decomposed as the oxygen reduction reaction progresses. Therefore, the metal based macrocyclic compounds cannot provide long-term stable operation of the fuel cells and the air cells.

Moreover, as a non-platinum-based catalyst, a polypyrrole-cobalt complex catalyst obtained by electrolytic polymerization of a pyrrole-cobalt complex has been reported (Patent Document 1). By forming a poly-nuclear complex molecule derived from pyrrole, an active metal can be carried on a catalyst support in a high density. Measurement by a rotating disk electrode (RDE) shows that the number of reaction electrons is 3.6 in the oxygen reduction reaction, and a reaction occurs close to a 4-electron reduction in which water is produced from oxygen. However, further improvement in the oxygen reduction activity is desired.

### Patent Document 1

Japanese Patent Application Laid-Open No. 2005-066592

### Non-Patent Document 1

R. Jasinski, Nature 201 (1964): 1212.

### DISCLOSURE OF THE INVENTION

### Problems to be Solved by the Invention

As mentioned above, in order to provide electrochemical energy devices such as the fuel cells and the air cells involving the oxygen reduction reaction into practical use, first, an electrode catalyst that shows an oxygen reducing action equal to or more than that of the platinum particulate catalyst is needed for realization of higher energy conversion efficiency. Second, cost reduction is needed for wide spread of the electrochemical energy devices. Accordingly, a catalyst is needed in which the amount of a noble metal such as platinum used is as small as possible or no noble metal such as platinum is used. Furthermore, when use as an oxygen pole of the fuel cell or air cell is considered, a catalyst having chemical stability in an acid or alkaline solution and at a high potential for a long time is needed.

Based on such a background, an object of the present invention is to provide an oxygen reduction catalyst and an electrode catalyst using the oxygen reduction catalyst, the oxygen reduction catalyst having an oxygen reduction capacity equal to or more than that of a platinum particulate catalyst while having a smaller amount of a noble metal to be used and longer-term chemical stability compared to the platinum particulate catalyst.

### Means for Solving the Problems

In order to solve the problems, the present invention provides an electrode catalyst characterized by including an organometallic polymer structure in which a transition metal or zinc is coordinated with an organic polymer compound including a ligand comprising a heterocyclic 5-membered ring or a heterocyclic 6-membered ring containing at least not less than two elements selected from nitrogen (N), oxygen (O), sulfur (S), and selenium (Se), and derivatives thereof.

### Advantages of the Invention

By using an oxygen reduction catalyst including the organometallic polymer structure according to the present invention, the oxygen reduction catalyst can have an oxygen reduction capacity equal to or more than that of a platinum particulate catalyst even when the amount of a metal is smaller than that of the platinum particulate catalyst. Moreover, the oxygen reduction catalyst has an oxygen reduction capacity greatly exceeding that of a metal based macrocyclic compound. Further, by coordinating a metal with an organic polymer, stability in an oxygen reduced state can be significantly improved compared to a case of the metal based macrocyclic compound. Moreover, a site allowing metal coordination increases by using a heterocycle having a plurality of hetero atoms as a metal ligand. Accordingly, an active metal density per catalyst can be improved, and an oxygen reduction catalyst having a higher activity can be attained.

As for the oxygen reduction reaction, there are a 4-electron reaction and a 2-electron reaction. In the 4-electron reaction, an oxygen molecule is reduced to a water molecule (H₂O, in an acidic solution) or a hydroxide ion (OH⁻, in an alkali electrolyte), and in the 2-electron reaction, an oxygen molecule is reduced to hydrogen peroxide. It is desired that a catalyst for an oxygen reduction electrode used in energy devices such as the fuel cells or the air cells that demand a higher energy density is a catalyst that progresses by a 4-electron process whose equilibrium potential is a lower potential, as represented by the following formula:

O₂+4H⁺+4e⁻->2H₂O E⁰=1.229 V vs SHE (in an acidic electrolyte)

It is known that a metal atom involved in adsorption of an oxygen molecule is disposed at an interatomic distance of 0.25 nm to 0.55 nm thereby to attain a bridge type oxygen molecule adsorption structure, and the 4-electron type reduction reaction is accelerated through dissociation to oxygen atoms and a protonation process. The interatomic distance of the metal is approximately equal to a distance between nearest neighbor atoms on a metal particulate catalyst such as platinum, and is approximately a half of that in metal based macrocyclic compounds such as phthalocyanine and porphyrin. The oxygen reduction catalyst using the organometallic polymer structure according to the present invention has the distance between the metal atoms within the above-mentioned range. Accordingly, the oxygen reduction reaction progresses mainly by the 4-electron process, and the oxygen reduction catalyst can have a higher oxygen reduction activity. Further, compared with the metal particulate catalyst, the amount of the metal to be used can be significantly reduced by two-dimensionally producing an organometallic polymer.

Moreover, the oxygen reduction catalyst using the organometallic polymer structure according to the present invention is characterized in that a polymer-like main chain is formed. With this polymer structure, an electron state of a coordinated metal can be easily changed, and the oxygen reduction reaction can occur with precedence. Simultaneously, stability of the catalyst during the oxygen reduction reaction can be improved. Moreover, the oxygen reduction catalyst using the organometallic polymer structure according to the present invention is characterized in that a heterocycle having a plurality of hetero atoms is used as the metal ligand. The metal atom is coordinated with the plurality of hetero atoms. Accordingly, it is expected that sites allowing coordination of the metal are increased by increase in the number of the hetero atoms that form the ligand. Thereby, an active metal density per catalyst can be improved, and the distance between the metal atoms can be shortened. As a result, an oxygen reduction catalyst having a higher activity can be attained.

For the above-mentioned reasons, it is possible to provide a catalyst that has an oxygen reduction capacity equal to or more than that of a noble metal based particulate catalyst, uses a reduced amount of a metal, and has higher stability as well. Moreover, by using a heterocycle having a plurality of hetero atoms as a metal ligand, the sites allowing coordination of the metal are increased compared to the case of a heterocycle having only a singular number of a hetero atom. Thereby, a probability that the metal is coordinated with the site allowing coordination is increased at the time of synthesis, and production of an oxygen reduction catalyst having a higher activity is facilitated.

### BRIEF DESCRIPTION OF THE DRAWINGS

FIG. 1 is a structure model diagram of an organometallic polymer structure in which Pt is coordinated with a polymer containing pyrimidine;

FIG. 2 shows rotating disk electrode measurement in an oxygen reduction reaction of a GC-organometallic polymer structure electrode in which Co, Ni, Fe, and Pt each are coordinated with a polymer containing GC and bipyrimidine;

FIG. 3 shows rotating disk electrode measurement in an oxygen reduction reaction of a GC-organometallic polymer structure electrode in which Co, Ni, Fe, and Pt each are coordinated with a polymer containing hexyl bipyrimidine;

FIG. 4 shows rotating disk electrode measurement in an oxygen reduction reaction of a GC-organometallic polymer structure electrode in which Co, Ni, Fe, and Pt each are coordinated with a polymer containing bipyrimidine sulfonic acid;

FIG. 5 shows results of rotating disk electrode measurement in an oxygen reduction reaction of a GC-organometallic polymer structure electrode in which Co, Ni, Fe, and Pt each are coordinated with a polymer containing 6,6′ ethyl thiol-2,2′-pyrimidine;

FIG. 6 shows rotating disk electrode measurement in an oxygen reduction reaction of a GC-organometallic polymer structure electrode in which Co, Ni, Fe, and Pt each are coordinated with a polymer containing bipyrimidine into which a dopant is injected;

FIG. 7 shows discharge characteristics of a fuel cell in which an organometallic polymer structure having Ni coordinated with a polymer containing bipyrimidine is used as a cathode electrode catalyst;

FIG. 8 shows discharge characteristics of a coin type air zinc carbon cell in which a polymer containing Ni-bipyrimidine is used as a cathode electrode catalyst; and

FIG. 9 shows a polymer structure in which a principal component of a main chain is propane and a substituent of the main chain (side chain ligand) is pyrazole.

### BEST MODE FOR CARRYING OUT THE INVENTION

### Description of a Configuration

As an electrode catalyst that uses a small amount of a metal and has an oxygen reduction capacity equal to or more than that of a platinum particulate catalyst, the present invention provides an oxygen reduction catalyst characterized by including an organometallic polymer structure in which a transition metal or zinc is coordinated with an organic polymer compound including a ligand comprising a heterocyclic 5-membered ring or a heterocyclic 6-membered ring containing at least not less than two elements selected from nitrogen (N), oxygen (O), sulfur (S), and selenium (Se), and derivatives thereof.

The catalyst according to the present invention has a structure in which a metal atom in an atom or ion form is coordinated with a ligand comprising an organic compound similar to a metal based macrocyclic compound such as metal coordinated porphyrin and phthalocyanine. However, the metal atoms are disposed at a shorter distance between metal atoms (0.25 nm to 0.55 nm) and in a higher density compared to the case of the metal based macrocyclic compound. As a result, an oxygen reduction reaction by the 4-electron process is accelerated, and an efficient oxygen reduction reaction is realized.

Preferably, in the organic polymer compound, the ligand is a main chain or a part of the main chain of the organic polymer compound, or a side chain or a part of the side chain thereof. When the ligand with which a metal is coordinated forms the main chain or a part of the main chain of a polymer, or when the ligand is bonded to the main chain to form a side chain, the electron state of the coordinated metal becomes advantageous for the oxygen reduction reaction, and stability of an organic skeleton is increased at the time of the oxygen reduction reaction.

As the main chain of the organic polymer compound in which the ligand comprising a heterocyclic 5-membered ring or a heterocyclic 6-membered ring including nitrogen (N), oxygen (O), sulfur (S), and selenium (Se), and derivatives thereof is a part of the main chain, a side chain, or a part of the side chain, such a main chain includes main chains of units comprising the ligand comprising a heterocyclic 5-membered ring or a heterocyclic 6-membered ring including nitrogen (N), oxygen (O), sulfur (S), and selenium (Se), and derivatives thereof, and aliphatic series or aliphatic series conjugated systems, as follows: polybipyridyl vinylene, polybipyridyl propane, poly triathyl vinylene, poly triathyl propane, poly pteridyl vinylene, poly pteridyl propane, poly imidazolium vinylene, poly imidazolium propane, poly selenazolium vinylene, poly selenazolium propane, poly furazanium vinylene, poly furazanium propane, polybipyridyl vinylene, polybipyridyl propane, polybipyridyl triathyl vinylene, poly selenazolium pteridyl propane, etc.

The ligand that forms a main chain, a part of the main chain, a side chain, or a part of the side chain is a ligand comprising a heterocyclic 5-membered ring or a heterocyclic 6-membered ring containing at least not less than two elements selected from nitrogen (N), oxygen (O), sulfur (S), and selenium (Se), and derivatives thereof. Specifically, imidazole, pyrazole, thiazole, isothiazole, selenazole, isoselenazole, oxazole, isoxazole, furazan, 1,2,3-triazole, 1,2,4-triazole, pyrazine, pyrimidine, pyridazine, trithiane, 1,8-naphthyridine, and pteridine are preferable.

Any of transition metals that can act as an adsorption site for oxygen may be used for the metal coordinated with the organic polymer compound. Among them, at least one metal selected from Sc, Ti, V, Cr, Mn, Fe, Co, Ni, Cu, Zr, Nb, Mo, Ru, Rh, Pd, Ag, Ir, Pt, and Au is preferably coordinated. Except the transition metals, Zn is also preferable. The metal atom is the adsorption site for an oxygen molecule, and simultaneously can act as an active site for dissociation of an oxygen molecule and a protonation process of oxygen atoms.

At least a part of hydrogen (H) included in the main chain or side chain of the organometallic polymer structure can also be substituted with a substituent. Alkyl groups and alkylene groups can be used as the substituent. Alkyl groups include linear alkyl groups such as a methyl group, an ethyl group, a propyl group, a pentyl group, a hexyl group, a heptyl group, and an octyl group; and branched alkyl groups such as an isopropyl group, an isobutyl group, a sec-butyl group, a tert-butyl group, an isopentyl group, a neo-pentyl group, a tert-pentyl group, and an isopentyl group. Alkylene groups include linear alkylene groups such as a vinyl group, a propylene group, a pentene group, a hexene group, a heptene group, and an octene group; and branched alkylene groups such as an isopropylene group, an isobutylene group, a sec-butylene group, a tert-butene group, an isopentene group, a neo-pentene group, a tert-pentene group, and an isopentene group.

At least a part of hydrogen (H) included in the main chain, side chain, or the substituent of the organometallic polymer structure can also be substituted with a functional group. Halogens and a sulfonic group can be used as the functional group. Halogens include fluorine, chlorine, bromine, and iodine.

At least a part of hydrogen (H) included in the main chain, side chain, substituent, or functional group of the organometallic polymer structure can also be substituted with a ligand. As the ligand for substitution, the ligands, an amino group, an imino group, a carboxyl group, a hydroxy group, oximes, ketones, an aldehyde group, thiols, phosphine, arsine, selenide, a thiocarboxyl group, a dithiocarboxyl group, and dithiocarbamate can be used. By substitution with these substituents, functional groups, and ligands, the electron state of the metal in the metal ligand and the interatomic distance thereof can be adjusted, or hydrophilicity or hydrophobicity can be used. As a result, an electrocatalytic reaction and substance transportation accompanied by the electrocatalytic reaction can be improved.

For increase in the number of the active sites per unit surface area, it is preferable that the metal atom of the organometallic polymer structure is coordinated directly with the ligand that forms the main chain. Further, for increase in the metal coordination active site, a ligand can be introduced also into the side chain, and the metal can be coordinated with the ligand. As the ligand included in the side chain, the ligand used for the main chain can be introduced. The ligand introduced into the side chain also controls the distance between adjacent ligands, and adjusts steric hindrance and polarity repellence to improve orientation. This increases a probability that the metal is coordinated with the coordination site, or increases an efficiency of transportation of a reactant or a product. As a result, a highly active oxygen reduction catalyst can be attained.

Preferably, the main chain or side chain of the organometallic polymer structure has electrical conductivity. This is because electrons move quickly at the time of the electrocatalytic reaction so that the catalytic activity is increased. In order to increase the electrical conductivity, the main chain can also be doped. As the dopant, electron receptive dopants include halogen molecules such as iodine, bromine, etc.; strong Lewis acids such as arsenic pentafluoride, antimony pentafluoride, iron trichloride, etc.; proton acids such as sulfuric acid, fluorosulfonic acid, etc.; transition metal compounds such as iron trichloride, titanium tetrachloride, etc.; electrolyte anions such as chloride ions, perchlorate ions; and substances having large electron affinity, etc. Electron donative dopants include substances generally having small ionization potential, such as alkali metals such as Li, Na, K, Rb, Cs, etc.; alkaline earth metals such as Ca, Sr, Ba, etc.; and lanthanoid metals such as Eu, etc.

Further, even when neither main chain nor side chain has the electrical conductivity, use of the organometallic polymer structure as an oxygen reduction catalyst is allowed by adding a conductivity imparting agent. In order to give the electrical conductivity, fibrous carbon, particulate carbon, carbon nanotube and derivatives thereof, fullerene and derivatives thereof, and the like can also be added. Further, inorganic compounds such as oxides and nitrides having electrical conductivity, metals, conductive polymers, molecular crystals, and the like may be added. Even when the main chain and the side chain have the electrical conductivity, the activity may be increased by adding a conductivity imparting agent.

When a metal is coordinated with the ligand of the organic polymer compound, a polymer including the ligand is synthesized. Subsequently, a metal salt including a desired metal and a complex including a ligand having a coordination capacity lower than that of the synthesized polymer including the ligand are mixed with a solvent in which the polymer dissolves. Thereby, the metal is coordinated with the ligand of the organic polymer compound. When a substitution reaction in the polymer including the ligand progresses slowly, the reaction is accelerated by increasing the amount of the polymer including the ligand to be supplied or by heating and stirring the polymer including the ligand. Moreover, there are some metal ions that become a complex having substitution activity to that having substitution inactivity, or vice versa, by change of an oxidation state of the same metal ion. The metal ion that is an element of the same kind having the substitution activity and the substitution inactivity includes, for example, bivalent and trivalent Co ions, trivalent and tetravalent Co ions, etc. Using this property, a new complex can also be manufactured by quickly performing the substitution reaction in the substitution active state, and subsequently changing into the substitution inactive state by oxidization or reduction. General oxidizers and reducers are used as both an oxidizer and a reducer. The oxidizer includes potassium permanganate, manganese dioxide, osmium tetroxide, nitric acid, etc. The reducer includes oxalic acid, sulfur dioxide, sodium thiosulfate, hydrogen sulfide, boron hydride, diborane, sodium thiosulfate, etc. Moreover, by an electrochemical technique, the metal can be coordinated, or the polymer can be synthesized and simultaneously the metal can be coordinated.

An electrode catalyst including the oxygen reduction catalyst can be used as an electrode catalyst for the fuel cells and the air cells. The fuel cells can use an electrolytic solution having any kind of a property, namely, an acidic solution, an alkaline solution, and a neutral solution. A fuel for the fuel cells has no limitation, and hydrogen and hydrogen compounds can be used. This is also the case for the air cells, and any electrolytic solution and negative electrode active material can be used without limitation.

When the oxygen reduction catalyst according to the present invention is used as the electrode catalyst for the fuel cells and the air cells, the oxygen reduction catalyst may be directly dispersed or applied onto a current collection electrode. Alternatively, the oxygen reduction catalyst may be dispersed or applied onto a support made of a material, such as carbon particulates, having a large specific surface and electrical conductivity. In order to make the amount of the metal as small as possible, it is preferable that several layers of the oxygen reduction catalyst are carried on a support having such a large specific surface. The oxygen reduction catalyst may be carried as follows. A support may be mixed into a solution for polymer synthesis at the time of production of the catalyst to carry the formed polymer. Alternatively, the catalyst and a support may be mixed into a solvent with affinity such as isopropyl alcohol, stirred, and dried so that the catalyst is carried on the support. Further, when the carried catalyst is used as a catalyzer electrode, an additive having ion conductivity such as a binder and the like can also be added. However, a method for carrying the catalyst will not be limited to the above-mentioned methods. As long as the catalyst and an electrode electrically contact each other, the catalyst may be carried in any kind of a state.

### EXAMPLES

Hereinafter, although details of the present invention will be specifically shown in Examples, these will not limit the present invention at all.

### Example 1

### Synthesis of the Organometallic Polymer Structure

By the following method, a metal coordinated polymer structure was produced, in which Co, Ni, Fe, and Pt each were coordinated with a polymer including a ligand comprising a heterocyclic 6-membered ring including two nitrogen atoms (N) as a main chain.

Synthesis of the polymer including a ligand comprising a heterocyclic 6-membered ring including two nitrogen atoms (N) as a main chain was performed by the following procedure. First, using dimethylformaldehyde as a solvent, 2,2′-dibromo-5,5′-bipyrimidine, bis(1,5-cyclooctadiene)nickel, 1,5-cyclooctadiene, and bipyridine are dissolved. Subsequently, dimethylfuran is added to the produced solution. When the solution is stirred at 60° C. for 2 hours, a yellow solid object is deposited. The deposited solid object is washed in order of toluene, ethylenediaminetetraacetic acid of pH=3, ethylenediaminetetraacetic acid of pH=9, sodium hydroxide of pH=9, distilled water, and benzene. Thus, the target polymer was obtained. (Hereinafter, the target polymer is referred to as a polymer containing bipyrimidine.)

Next, the obtained polymer containing bipyrimidine was dried in a vacuum. Co, Ni, Fe, and Pt each were coordinated with a ligand comprising bipyrimidine by the following method. Coordination of Co was performed by dissolving the polymer containing bipyrimidine and cobalt dibromide into a dimethylformamide solution under a nitrogen atmosphere, and stirring the solution. Coordination of Ni was performed by slowly adding a toluene solution in which the polymer containing bipyrimidine was dissolved while stirring a toluene solution in which bis(1,5-cyclooctadiene)nickel was dissolved under a nitrogen atmosphere. Coordination of Fe was performed by refluxing and stirring a dimethylformamide solution including the polymer containing bipyrimidine and iron dibromide under a nitrogen atmosphere. Coordination of Pt was performed by slowly adding a toluene solution, in which the polymer containing bipyrimidine was dissolved, into a stirred bis(1,5-cyclooctadiene)platinum-toluene solution under a nitrogen atmosphere. Subsequently, each deposited product was filtered and dried in a vacuum.

### Example 2

### A Structure of the Organometallic Polymer Structure

Structural analysis was performed on the obtained organometallic polymer structure by ultraviolet-visible-NIR spectroscopy (UV-Vis-NIR), X-ray absorption spectroscopy (EXAFS), X-ray photoelectron spectroscopy (XPS), and infrared absorption spectroscopy (IR). As a result of the analysis, each metal of Co, Ni, Fe, and Pt existed between the grown polymers containing bipyrimidine, and coordinate bonded to an N section. FIG. 1 shows a model diagram of a metal coordinated polymer structure in which Pt is coordinated with the polymer containing bipyrimidine. In FIG. 1, Pt exists between pyrimidines, one Pt atom is coordinate bonded to four Ns in four molecules of pyrimidine. This coordination bond is stabilized. At this time, a distance between adjacent Pt atoms is 0.45 nm. Moreover, a distance between adjacent metals in the organometallic polymer structure in which each of Co, Ni, and Fe was coordinated with bipyrimidine was as follows. The organometallic polymer structure in which Ni was coordinated with bipyrimidine (polymer containing Ni-bipyrimidine; hereinafter, abbreviated as in the preceding manner): 0.40 nm, the polymer containing Co-bipyrimidine: 0.42 nm, and the polymer containing Fe-bipyrimidine: 0.53 nm. It is thought that the organometallic polymer structure thus produced has a reaction site comprising coordinated metal-atom, and the reaction sites are distributed in a high density while keeping a distance of 0.25 nm to 0.55 nm.

### Example 3

### Electrochemical Characteristics of the Metal Coordinated Polymer Structure

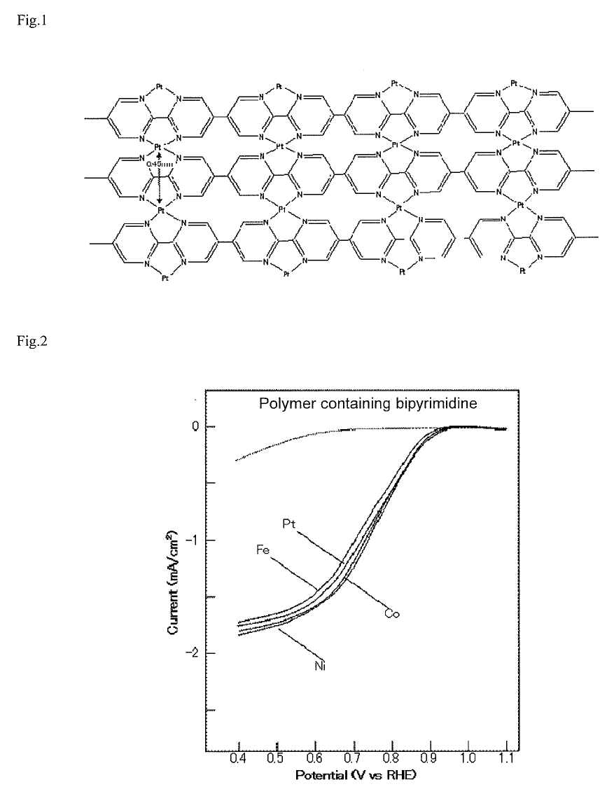

The oxygen reduction capacity of the produced organometallic polymer structure was evaluated by the following method. In production of an electrode, distilled water was added to the organometallic polymer structure made into powders using a mortar, and a dispersion was produced by ultrasonic irradiation. The dispersion was dropped so that the organometallic polymer structure of 10 μg might be carried on a glassy carbon (GC) electrode having a diameter of 3 mm and polished well, and dried. Thereby, a GC-organometallic polymer structure electrode was produced. FIG. 2 shows the results of rotating disk electrode (RDE) measurement in an oxygen reduction reaction (ORR) of the GC-organometallic polymer structure electrode in which Co, Ni, Fe, and Pt each are coordinated with a polymer containing GC and bipyrimidine. A solution for measurement is an aqueous solution of 0.5 M H₂SO₄ saturated with oxygen. A sweep rate is 10 mV/s and the number of rotations of the electrode is 400 rpm. A dotted line shows the ORR measurement result of only GC. A cathode current resulting from oxygen reduction is observed from the vicinity of 0.6 V. However, the current density is low and the ORR hardly progresses. Solid lines show the ORR measurement results of the GC-organometallic polymer structure electrode in which Co, Ni, Fe, and Pt each are coordinated with the polymer containing bipyrimidine. A large cathode current resulting from oxygen reduction is observed from the vicinity of 0.85 V, and it turns out that the ORR progresses. An oxygen reduction initial potential was on a potential side higher than 0.9 V. An oxygen reduction overvoltage was approximately 0.3 V and lower than an overvoltage of an electrode using a Pt particulate as a catalyst (approximately 0.4 V).

The number of reaction electrons of the oxygen reduction catalyst in the GC-organometallic polymer structure electrode was calculated. As a calculating method, a Koutecky-Levich plot showing a relationship between the number of rotations of the electrode and a diffusion limiting current in the RDE is produced. On the basis of the slope of the obtained line, the number of reaction electrons is calculated using the Koutecky-Levich equation. A sample potential is 0.4 V, and reaches a diffusion current. As a result of calculation, the number of reaction electrons of each GC-organometallic polymer structure electrode was as follows: the polymer containing Ni-bipyrimidine: 3.7, the polymer containing Co-bipyrimidine: 3.9, the polymer containing Pt-bipyrimidine: 3.7, and the polymer containing Fe-bipyrimidine: 3.6. The number of reaction electrons of the oxygen reduction catalyst in which a Co atom is coordinated with the polymer containing bipyrimidine and that has the highest oxygen reduction capacity is 3.9. The ORR progresses by approximately the 4-electron process. On the other hand, also in the oxygen reduction catalyst in which an Fe atom is coordinated with the polymer containing bipyrimidine and that has the lowest oxygen reduction capacity, the number of reaction electrons is 3.5. In most of the oxygen reduction reaction, the ORR progresses by the 4-electron process.

### Example 4

### Introduction of the Substituent and an Effect of the Introduction

Measurement was performed about electrochemical characteristics of the organometallic polymer structure in which Co, Ni, Fe, and Pt each were coordinated with a polymer containing hexyl bipyrimidine obtained by introducing a hexyl group into the polymer containing bipyrimidine. Then, an effect of introduction of the substituent was examined.

Synthesis of the polymer was performed by the same method as that in Example 1 except that 2,2′-dibromo-5,5′-bipyridine was replaced with 2,2′-dibromo-6,6′-hexyl-5,5′-bipyrimidine. Coordination of various metals was also performed by the same method as that of Example 1.

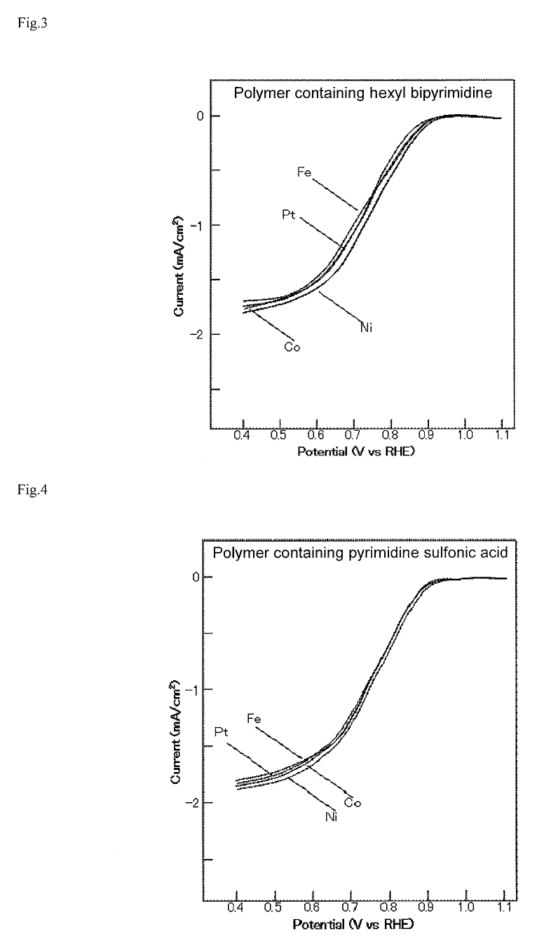

A GC-organometallic polymer structure electrode, in which the organometallic polymer structure in which Co, Ni, Fe, and Pt each were coordinated with the polymer containing hexyl bipyrimidine was carried on a GC electrode, was produced by the same method as that in Example 3. FIG. 3 shows results of the rotating disk electrode measurement in the oxygen reduction reaction of the GC-organometallic polymer structure electrode in which Co, Ni, Fe, and Pt each are coordinated with the polymer containing hexyl bipyrimidine. A solution for measurement is an aqueous solution of 0.5 M H₂SO₄ saturated with oxygen. The sweep rate is 10 mV/s and the number of rotations of the electrode is 400 rpm. Compared with the measurement results of the GC-organometallic polymer structure electrode of FIG. 1 in which Co, Ni, Fe, and Pt each were coordinated with the polymer containing bipyrimidine, the oxidation reduction initial potential was the vicinity of 0.95 V and approximately equal to that in the above-mentioned measurement result. The current density was also approximately the same value as that in the above-mentioned measurement result in all potential regions. Thus, a higher oxygen reduction capacity was observed. The current density was increased particularly in the polymer containing Pt-hexyl bipyrimidine compared to that in the organometallic polymer structure of bipyrimidine. It is thought that this is because structural order of the organometallic polymer structure is improved by interaction given by an alkyl group, and because an increased inter-layer distance of the organometallic polymer structure increases a frequency at which oxygen molecules and protons of a reactant reach the reaction site.

### Example 5

### Introduction of a Functional Group and an Effect of the Introduction

Measurement was performed about electrochemical characteristics of an organometallic polymer structure in which Co, Ni, Fe, and Pt each were coordinated with a polymer containing bipyrimidine and sulfonic acid obtained by introducing a sulfonic group into the polymer containing bipyrimidine. Then, an effect of introduction of the functional group was examined.

As for synthesis of the polymer containing bipyrimidine and sulfonic acid, the polymer containing bipyrimidine synthesized in Example 1 was processed using concentrated sulphuric acid. Subsequently, a precipitate was filtered, and dried in a vacuum. The obtained precipitate was washed by benzene, hydrochloric acid, and boiling water, and dried in a vacuum. Subsequently, coordination of various metals was performed by the same method as that in Example 1.

As for measurement of the oxygen reduction capacity of the organometallic polymer structure, an electrode was produced by the same method as that in Example 3, and measurement was made on the same conditions. FIG. 4 shows results of rotating disk electrode measurement of an oxygen reduction reaction in the GC-organometallic polymer structure electrode in which Co, Ni, Fe, and Pt each are coordinated with the polymer containing bipyrimidine and sulfonic acid. The GC-organometallic polymer structure electrode had a high oxygen reduction capacity similarly to the cases of Example 3 and Example 4. Particularly in the diffusion limiting current region in the vicinity of 0.4 V, a current density higher than those of Example 3 and Example 4 was shown. This shows that sulfonation increases hydrophilicity and oxygen permeability of the organometallic polymer structure, and improved supply of protons and oxygen of a reactant.

### Example 6

### Introduction of a Side Chain Ligand and an Effect of the Introduction

Measurement was performed about electrochemical characteristics of an organometallic polymer structure in which Co, Ni, Fe, and Pt each were coordinated with a polymer containing 6,6′-ethylthiol-2,2′-pyrimidine obtained by introducing an ethylthiol group into the polymer containing pyrimidine. Then, an effect of introduction of the side chain ligand was examined.

Synthesis of the polymer containing 6,6′-ethylthiol-2,2′-pyrimidine was performed by the same method as that in Example 1 except that the monomer was replaced with 1,1′-ethylthiol-2,2′-dibromo-5,5′-pyrimidine. Subsequently, coordination of various metals was performed by the same method as that in Example 1.

An electrode was produced by the same method as that in Example 3, and the oxygen reduction capacity of the organometallic polymer structure was measured on the same conditions. FIG. 5 shows results of rotating disk electrode measurement of the oxygen reduction reaction in the GC-organometallic polymer structure electrode in which Co, Ni, Fe, and Pt each are coordinated with the polymer containing 6,6′-ethylthiol-2,2′-pyrimidine. The oxidation reduction initial potential was in the vicinity of 0.95 V similarly to the result of Example 3. Further, the oxidation reduction current was higher than those in Example 3 and Example 4 in all potential regions. This is because a thiol group introduced into the side chain acted as a ligand, and a metal was coordinated with the thiol group, so that the reaction sites were increased. As a result, an amount of the reaction was increased so that a current value was increased.

### Example 7

### Introduction of a Dopant and an Effect of the Introduction

Measurement was performed about electrochemical characteristics of a metal coordinated polymer structure in which Co, Ni, Fe, and Pt each were coordinated with the polymer containing pyrimidine doped by introduction of a dopant. Then, an effect of introduction of the dopant was examined.

The polymer containing bipyrimidine synthesized by the method of Example 1 was doped by the following method. Doping of the polymer containing bipyrimidine with Na was performed by dipping the polymer containing bipyrimidine into a tetrahydrofuran solvent including naphthalene and Na under a nitrogen atmosphere. Subsequently, the obtained solid was dried in a vacuum.

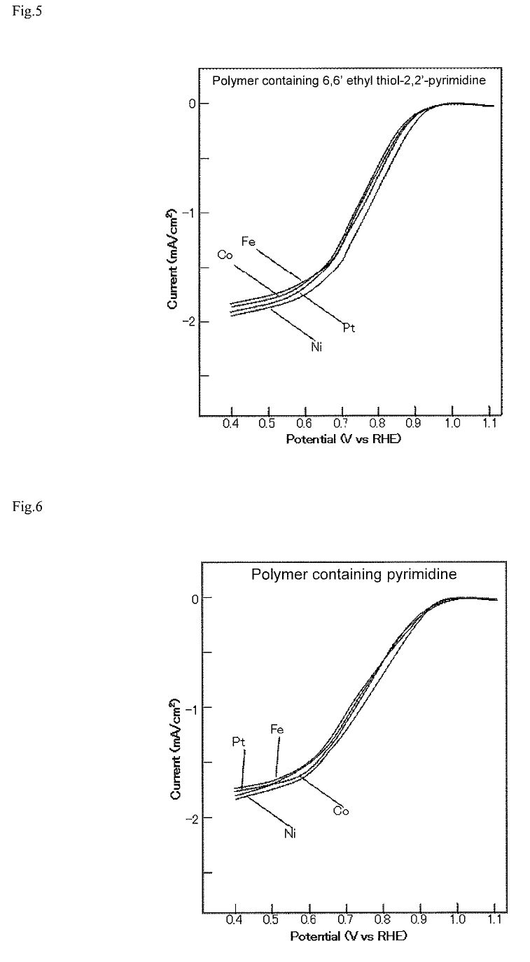

An electrode was produced by the same method as that in Example 3, and the oxygen reduction capacity of the organometallic polymer structure was measured on the same conditions. FIG. 6 shows results of rotating disk electrode measurement of the oxygen reduction reaction of the GC-organometallic polymer structure electrode in which Co, Ni, Fe, and Pt each are coordinated with the polymer containing bipyrimidine into which the dopant is introduced. The oxidation reduction initial potential was 0.97 V, and was on the potential side higher than that in the result of Example 3. The oxidation reduction current had approximately the same value as that in Example 3. The overvoltage of the oxidation reduction potential became lower than that in Example 3. It is thought that this is because a degree of electron conduction of the polymer containing bipyrimidine, which is a carbon skeleton, was improved by doping. As a result, the electrons moved quickly at the time of the electrocatalytic reaction so that the catalytic activity was increased.

### Example 8

### Manufacturing of an Electrode Catalyst for Fuel Cells, and Evaluation of Properties

A fuel cell using the organometallic polymer structure according to the present invention as a cathode electrode catalyst was produced, and the properties thereof were evaluated.

The organometallic polymer structure produced in Example 1 in which Ni was coordinated with the polymer containing bipyrimidine was used as a cathode electrode catalyst. A small-sized test fuel cell was produced in accordance with the following procedure. First, as a diffusion layer, a diffusion layer subjected to water repellent treatment was prepared by applying carbon black made water repellent by polytetrafluoroethylene (PTFE) dispersion onto the surface of a carbon cloth. Next, powders of the organometallic polymer structure, in which Ni is coordinated with the polymer containing bipyrimidine, as a cathode electrode catalyst, and a platinum particulate catalyst having a metallic component of 50 wt mass % and carried on Ketjen Black (trade name, made by Lion Corporation) as an anode catalyst are mixed with a Nafion solution (polymer content of 5 mass %, made by Sigma-Aldrich Corporation), respectively. Each mixture was applied onto the surface of the diffusion layer subjected to water repellent treatment, and dried. Thereby, a catalyst layer was formed on the surface of the diffusion layer to obtain gas diffusion electrodes for a cathode and for an anode.

Subsequently, both sides of an electrolyte membrane (a Nafion (registered trademark) membrane having a thickness of approximately 50 μm, made by E. I. du Pont de Nemours and Company) were thermocompression bonded to the gas diffusion electrodes, with each catalyst layer of the gas diffusion electrodes facing inward. Thus, a membrane electrode assembly (MEA) was obtained. Further, the MEA was sandwiched between current collectors each including a graphite plate provided with a gas flow passage, thus to obtain a test fuel cell.

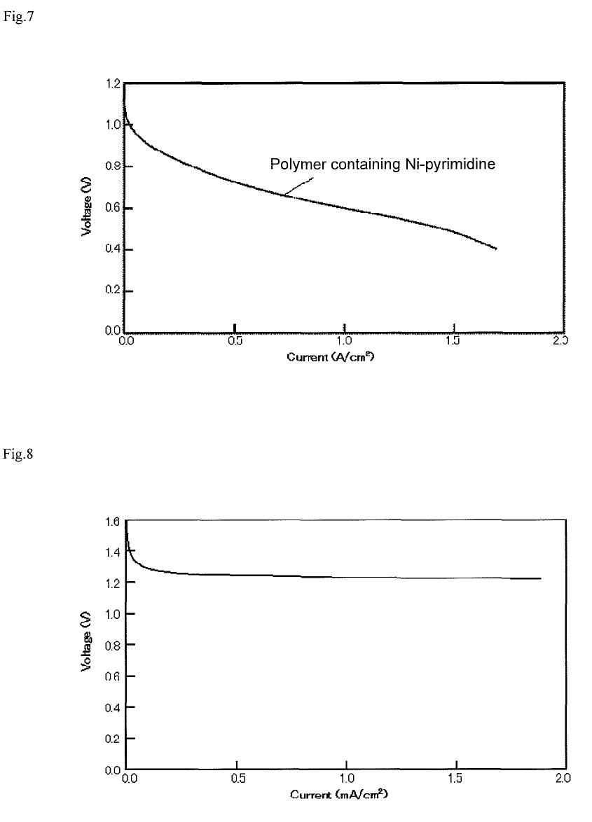

FIG. 7 shows a result of an electric discharge test of a hydrogen-air fuel cell in which the organometallic polymer structure in which Ni is coordinated with the polymer containing bipyrimidine is used for the cathode electrode catalyst. As test conditions, a cell temperature is 80° C., hydrogen and air pressures are 2.0 atm, a hydrogen flow rate is 5 ml/s, and an air flow rate is 9 ml/s. A gas dew-point temperature of hydrogen is 80° C. and that of air is 70° C. When the polymer containing Ni-bipyrimidine was used, a fuel cell having a high catalytic activity of the cathode electrode could be produced. Moreover, a high voltage was kept even when the current density was increased. Furthermore, a cell voltage was held at 0.6 V as a durability test. When the polymer containing Ni-bipyrimidine was used as the cathode electrode catalyst, a stable current density of approximately 1.0 A/cm² was observed for not less than 250 hours. Since the portion with which a metal in an atom or ion form is coordinated forms a polymer chain as mentioned above, the polymer chain becomes firm, and breakage of the catalyst is prevented. As a result, stable electric discharge is allowed for a long time.

### Example 9

### Manufacturing of an Electrode Catalyst for Air Cells, and Evaluation of the Properties

The polymer containing Ni-bipyrimidine was used for the cathode electrode catalyst, and a coin type air zinc cell was produced. Then, the properties thereof were evaluated.

A method for manufacturing the coin type air zinc cell is the same as a method for producing a typical coin type air cell. A negative electrode can (a product made of stainless steel coated with a corrosion resistant coating) filled with a zinc mixture comprising zinc powders and 40% potassium hydroxide gelled by starch and the like was sealed by a separator formed of a porous resin film such as polypropylene and polyethylene. Next, a positive electrode catalyst layer and a microporous Teflon film (Teflon: registered trademark) were attached to an outer side of the separator, the positive electrode catalyst layer being obtained by coating a nickel wire net with a sludge obtained by kneading powders of the polymer containing Ni-bipyrimidine produced in Example 1, carbon black, and an Ni-methyl-pyrrolidone solution in which polyvinylidene fluoride was dissolved. Subsequently, using an insulating gasket made of a plastic, a positive electrode can provided with an air inlet hole was sealed to the negative electrode can, to which the separator, the catalyst layer, and the Teflon film were attached, so as to insulate the negative electrode can and the positive electrode can from each other.

FIG. 8 shows a result of an electric discharge test of the produced coin type air cell at room temperature. A flat discharge curve was recorded at a high voltage of 1.3 V. From this, it is thought that the organometallic polymer structure according to the present invention is effective as the cathode electrode catalyst for the air cell.

### Example 10

### Other Polymer Components, Ligands, Metals, Etc

Organometallic polymer structures including other polymer main chains, side chains, ligands, functional groups, substituents, metallic components, etc., which are not described in Examples 1 to 9, were synthesized, and those effectiveness was examined. A synthesizing method and an evaluation method of the structure were the same as those described in Examples 1 and 2, respectively. Evaluation of the oxygen reduction capacity was performed by the method described in Example 8. The anode catalyst was an alloy catalyst of PtRu (mass ratio=50/50) carried on Ketjen Black with a metallic component of 20 mass %, and a catalyzer electrode onto which the alloy catalyst was applied so as to have a metallic component of 10 mg/cm² was used. The cathode catalyst was prepared so that the metallic component in the organometallic polymer structure might be 5×10⁻⁵ mol/cm², thereby enabling comparison of a cell output per metallic component included in the catalyst. Additionally, a cell in which carbon black as a conductivity imparting agent was mixed with the organometallic polymer structure was also produced. An output of the fuel cell was measured at 10 hours after operation of the cell and at 10,000 hours after operation.

Table 1 shows results of the fuel cells in which various metal coordinated organometallic polymer catalysts including a ligand in the main chain are used as the oxygen reduction catalyst.

TABLE 1

| | | | | | | | | | Cell |
|---|---|---|---|---|---|---|---|---|---|
| | | | | | | | | Cell | output |
| | | Main chain | | | Distance | | | output | (after |
| Main chain | | substituent | | | between | | Conductivity | (after 10 | 10,000 |
| principal | Main chain | (side chain | Side chain | Coordinated | metals | | imparting | hours) | hours) |
| component | ligand | component) | ligand | metal | (nm) | Dopant | agent | (mw/cm²) | (mw/cm²) |
| Pyrazine | Pyrazine | — | — | Ni | 0.315 | Na | — | 196 | 165 |
| Piperazine | Piperazine | — | — | Cu | 0.295 | Na | — | 197 | 139 |
| Pyridazine | Pyridazine | — | — | Fe | 0.305 | Na | — | 199 | 159 |
| Seleno | Seleno | — | — | Zr | 0.359 | — | Particulate | 194 | 156 |
| morpholine | morpholine | | | | | | carbon | | |
| Dioxene | Dioxene | — | — | Rh | 0.369 | Iodine | — | 179 | 157 |
| Triathine | Triathine | — | — | Ag | 0.367 | Iodine | — | 171 | 139 |
| Thioxan | Thioxan | 1-butene | — | Fe | 0.396 | Iodine | — | 170 | 164 |
| Quinazoline | Quinazoline | —C₈H₁₆N(CH₃)₂ | —N(CH3)₂ | Cr | 0.295 | — | Particulate | 189 | 142 |
| | | | | | | | carbon | | |
| Naphthyridine | Naphthyridine | —C₂H₄OH | —OH | Mo | 0.424 | Na | Particulate | 193 | 154 |
| | | | | | | | carbon | | |
| Phenanthroline | Phenanthroline | —C₃H₆C(═O)CH₃ | —C(═O)CH₃ | Pt | 0.336 | Na | Particulate | 176 | 149 |
| | | | | | | | carbon | | |
| Quinoxaline | Quinoxaline | —C₃H₆C(═O)CH₃ | —C(═O)CH₃ | Au | 0.299 | Na | Particulate | 187 | 143 |
| | | | | | | | carbon | | |
| Indazole | Indazole | —C₆H₁₀P(CH₃)₂ | —P(CH3)₂ | Ru | 0.457 | Iodine | Particulate | 186 | 158 |
| | | | | | | | carbon | | |
| Benzothiazole | Benzothiazole | —C₃H₆As(C₂H₆)₂ | —As(C₂H₆)₂ | Pd | 0.503 | Iodine | Particulate | 174 | 138 |
| | | | | | | | carbon | | |
| Benzimidazole | Benzimidazole | —C₃H₆SeCH₃ | —SeCH₃ | Ag | 0.298 | Iodine | Particulate | 178 | 129 |
| | | | | | | | carbon | | |
| Pyrrolo pyridine | Pyrrolo pyridine | —C₃H₆CSOH | —CSOH | Ru | 0.369 | Iodine | Particulate | 174 | 139 |
| | | | | | | | carbon | | |
| Phenoxathiin | Phenoxathiin | — | — | Ag | 0.462 | Iodine | — | 186 | 148 |
| Dibenzo dioxane | Dibenzo dioxane | — | — | Sc | 0.416 | Iodine | — | 190 | 144 |
| Methylenedioxy | Methylenedioxy | — | — | Ni | 0.497 | Iodine | — | 193 | 165 |
| benzene | benzene | | | | | | | | |
| Benzoxazole | Benzoxazole | — | — | Cu | 0.523 | Iodine | — | 182 | 147 |
| Thianthrene | Thianthrene | — | — | Nb | 0.463 | Iodine | — | 178 | 163 |
| Imidazole | Imidazole | — | — | Ti | 0.359 | Iodine | — | 184 | 159 |
| Pyrazole | Pyrazole | — | — | Sc | 0.476 | Iodine | — | 178 | 164 |
| Selenazole | Selenazole | — | — | Mn | 0.265 | Iodine | — | 178 | 163 |
| Isoselenazole | Isoselenazole | — | — | Co | 0.368 | Iodine | — | 193 | 172 |
| Thiazole | Thiazole | — | — | Zn | 0.419 | Iodine | — | 184 | 159 |
| Isothiazole | Isothiazole | — | — | Ir | 0.478 | Iodine | — | 186 | 160 |
| Oxazole | Oxazole | — | — | Pt | 0.523 | Iodine | — | 185 | 158 |
| Isoxazole | Isoxazole | — | — | Au | 0.489 | Iodine | — | 182 | 163 |
| Furazan | Furazan | — | — | Ni | 0.336 | Iodine | — | 191 | 168 |
| Triazole | Triazole | — | — | Cu | 0.356 | Iodine | — | 183 | 164 |
| Dioxane | Dioxane | — | — | Zr | 0.442 | Iodine | — | 192 | 161 |
| Pteridine | Pteridine | — | — | Nb | 0.501 | Iodine | — | 186 | 158 |

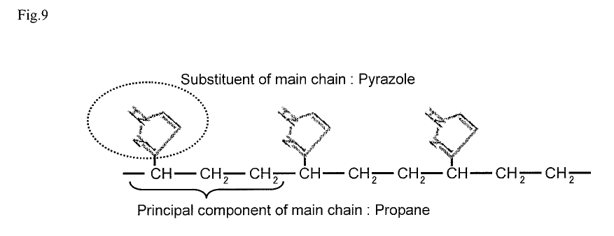

Table 2 shows results of the catalysts including a ligand in the side chain. When the ligand is included only in the side chain, very high properties may be obtained. As a method for synthesizing the catalyst including the ligand in the side chain, the polymer chain in the main chain was produced, and subsequently the side chain including the ligand was introduced, as an example will be shown below. The evaluation method of the structure and evaluation of the oxygen reduction capacity are the same as in the case of the results of the fuel cells using the various metal coordinated organometallic polymer catalysts including the ligand in the main chain as the oxygen reduction catalyst. First, toluene was used as a solvent, and chloro propylene was dissolved therein. Subsequently, when benzoyl peroxide was added to the produced solution and stirred at 60° C. for 2 hours, a white solid was deposited. Then, the deposited object was filtered, and washed by benzene, hydrochloric acid, and boiling water. Next, the deposited object and 4-bromopyrazole were dissolved in tetrahydrofuran. When n-butyl lithium was added to the produced solution and stirred at −78° C. for 2 hours, a target polymer was obtained. The target polymer was filtered, and washed by benzene, hydrochloric acid, and boiling water. As a result of analysis, as shown in FIG. 9, it is thought that the structure of the target polymer has propane as the principal component in the main chain, and the substituent of the main chain (side chain ligand) belongs to a structure of pyrazole. Then, coordination of various metals was performed by the same method as Example 1.

TABLE 2

| | | Main chain | | | | | | Cell output | Cell output |
|---|---|---|---|---|---|---|---|---|---|
| Main chain | | substituent | | | Distance | | Conductivity | (after 10 | (after 10,000 |
| principal | Main chain | (side chain | | Coordinated | between | | imparting | hours) | hours) |
| component | ligand | component) | Side chain ligand | metal | metals (nm) | Dopant | agent | (mw/cm²) | (mw/cm²) |
| Propane | — | Pyrrolo pyridine | Pyrrolo pyridine | Rh | 0.478 | — | Particulate | 182 | 148 |
| | | | | | | | carbon | | |
| Propane | — | Phenoxathiin | Phenoxathiin | Fe | 0.548 | — | Particulate | 179 | 171 |
| | | | | | | | carbon | | |
| Propane | — | Dibenzo dioxane | Dibenzo dioxane | Cr | 0.398 | — | Particulate | 193 | 143 |
| | | | | | | | carbon | | |
| Propane | — | Methylenedioxy | Methylenedioxy | Mn | 0.389 | — | Particulate | 187 | 145 |
| | | benzene | benzene | | | | carbon | | |
| Propane | — | Benzoxazole | Benzoxazole | Co | 0.498 | — | Particulate | 194 | 169 |
| | | | | | | | carbon | | |
| Propane | — | Thianthrene | Thianthrene | Ir | 0.485 | — | Particulate | 179 | 157 |
| | | | | | | | carbon | | |
| Propane | — | Imidazole | Imidazole | Au | 0.523 | — | Particulate | 185 | 161 |
| | | | | | | | carbon | | |
| Propane | — | Pyrazole | Pyrazole | Zn | 0.498 | — | Particulate | 179 | 159 |
| | | | | | | | carbon | | |
| Propane | — | Selenazole | Selenazole | Au | 0.378 | — | Particulate | 173 | 158 |
| | | | | | | | carbon | | |
| Propane | — | Isoselenazole | Isoselenazole | Zr | 0.415 | — | Particulate | 184 | 154 |
| | | | | | | | carbon | | |
| Propane | — | Thiazole | Thiazole | Ru | 0.365 | — | Particulate | 187 | 149 |
| | | | | | | | carbon | | |
| Propane | — | Isothiazole | Isothiazole | Rh | 0.475 | — | Particulate | 185 | 138 |
| | | | | | | | carbon | | |
| Propane | — | Oxazole | Oxazole | Pd | 0.489 | — | Particulate | 179 | 131 |
| | | | | | | | carbon | | |
| Propane | — | Isoxazole | Isoxazole | Ag | 0.369 | — | Particulate | 186 | 147 |
| | | | | | | | carbon | | |
| Propane | — | Furazan | Furazan | Ru | 0.286 | — | Particulate | 182 | 159 |
| | | | | | | | carbon | | |
| Propane | — | Triazole | Triazole | Rh | 0.294 | — | Particulate | 173 | 158 |
| | | | | | | | carbon | | |
| Propane | — | Dioxane | Dioxane | Ag | 0.425 | — | Particulate | 174 | 142 |
| | | | | | | | carbon | | |
| Acetylene | — | Piperazine | Piperazine | Ni | 0.483 | Iodine | — | 190 | 168 |
| Acetylene | — | Pyridazine | Pyridazine | Cu | 0.428 | Iodine | — | 176 | I57 |
| Acetylene | — | Seleno | Seleno | Au | 0.478 | Iodine | — | 187 | 162 |
| | | morpholine | morpholine | | | | | | |
| Acetylene | — | Morpholine | Morpholine | V | 0.416 | Iodine | — | 174 | 160 |
| Acetylene | — | Dioxene | Dioxene | Cr | 0.457 | Iodine | — | 175 | 149 |
| Acetylene | — | Triathine | Triathine | Co | 0.416 | Iodine | — | 195 | 174 |
| Acetylene | — | Thioxan | Thioxan | Mo | 0.385 | Iodine | — | 186 | 139 |
| Acetylene | — | Quinazoline | Quinazoline | Ir | 0.364 | Iodine | — | 185 | 165 |
| Acetylene | — | Naphthyridine | Naphthyridine | Zn | 0.549 | Iodine | — | 177 | 145 |
| Acetylene | — | Phenanthroline | Phenanthroline | Au | 0.298 | Iodine | — | 188 | 148 |
| Acetylene | — | Quinoxaline | Quinoxaline | Zr | 0.516 | Iodine | — | 176 | 152 |
| Acetylene | — | Indazole | Indazole | Rh | 0.441 | Iodine | — | 185 | 158 |

### Example 11

Measurement was performed in the same manner as in the case of Example 10. As the cathode catalyst, Pt particulates carried on Ketjen Black (trade name, made by Lion Corporation) with a metallic component of 50 mass % were applied so that the metallic component might be 10 mg/cm², and used. A cell output per metallic component included in the catalyst was 158 mW/cm² after 10 hours and 124 mW/cm² after 10,000 hours.

Apparently from the above-mentioned results, by using the oxygen reduction catalyst comprising the organometallic polymer structure according to the present invention, it is possible to provide a catalyst that has excellent stability and a high activity, and can reduce the amount of a metal.

This application claims priority on the basis of Japanese Patent Application No. 2007-217228 filed on Aug. 23, 2007, and whole contents of the disclosure are incorporated herein.

As mentioned above, while the present invention has been described with reference to the exemplary embodiments (and Examples), the present invention will not be limited to the above-mentioned exemplary embodiments (and Examples). Various modifications that a person skilled in the art can understand can be made to the configuration and details of the present invention within the scope of the present invention.

### INDUSTRIAL APPLICABILITY

An example of application of the present invention includes an oxygen reduction catalyst used for an electrode for electrochemical devices such as fuel cells and air cells that use oxygen as an oxidizer.

1. An oxygen reduction catalyst characterized by comprising an organometallic polymer structure in which a transition metal or zinc is coordinated with an organic polymer compound including a ligand comprising a heterocyclic 5-membered ring or a heterocyclic 6-membered ring containing at least not less than two elements selected from nitrogen (N), oxygen (O), sulfur (S), and selenium (Se), and derivatives thereof.

2. The oxygen reduction catalyst according to claim 1 characterized in that
the organic polymer compound includes the ligand as a main chain or a part of the main chain of the organic polymer compound.

3. The oxygen reduction catalyst according to claim 1 characterized in that
the organic polymer compound includes the ligand as a side chain or a part of the side chain of the organic polymer compound.

4. The oxygen reduction catalyst according to claim 1, wherein the ligand is at least one ligand selected from imidazole, pyrazole, thiazole, isothiazole, selenazole, isoselenazole, oxazole, isoxazole, furazan, 1,2,3-triazole, 1,2,4-triazole, pyrazine, pyrimidine, pyridazine, trithiane, 1,8-naphthyridine, and pteridine.

5. The oxygen reduction catalyst according to claim 1, wherein the transition metal is at least one metal selected from Sc, Ti, V, Cr, Mn, Fe, Co, Ni, Cu, Zr, Nb, Mo, Ru, Rh, Pd, Ag, Ir, Pt, and Au.

6. The oxygen reduction catalyst according to claim 1, characterized by comprising an organometallic polymer structure in which at least a part of hydrogen (H) included in the main chain or side chain of the organometallic polymer structure is substituted by at least one substituent selected among an alkyl group and a vinyl group.

7. The oxygen reduction catalyst according to claim 1 characterized by comprising an organometallic polymer structure in which at least a part of hydrogen (H) included in the main chain or side chain of the organometallic polymer structure is substituted by at least one functional group selected among halogens and a sulfonic group.

8. The oxygen reduction catalyst according to claim 1 characterized by comprising an organometallic polymer structure in which at least a part of hydrogen (H) included in the main chain or side chain of the organometallic polymer structure is substituted by the ligand according to claim 1, or at least one metal ligand selected among an amino group, an imino group, a carboxyl group, a hydroxy group, oximes, ketones, an aldehyde group, thiols, phosphine, arsine, selenide, a thiocarboxyl group, a dithiocarboxyl group, and dithiocarbamate.

9. An oxygen reduction catalyst characterized by comprising an organometallic polymer structure in which in the organometallic polymer structure according to claim 8, at least one metal selected from Sc, Ti, V, Cr, Mn, Fe, Co, Ni, Cu, Zr, Nb, Mo, Ru, Rh, Pd, Ag, Ir, Pt, and Au is coordinated with a ligand according to claim 8.

10. The oxygen reduction catalyst according to claim 1 characterized by comprising an organometallic polymer structure in which a main chain of the organometallic polymer structure is doped with an electron receptive dopant or an electron donative dopant.

11. The oxygen reduction catalyst according to claim 1 characterized in that a conductivity imparting agent is added.

12. An electrode catalyst wherein the organometallic polymer structure oxygen reduction catalyst according to claim 1 is carried on a support having electrical conductivity.

13. A fuel cell using the electrode catalyst according to claim 12.

14. An air cell using the electrode catalyst according to claim 12.

15. The oxygen reduction catalyst according to claim 6 characterized by comprising an organometallic polymer structure in which at least a part of hydrogen (H) included in the substituent according to claim 6 is substituted by at least one functional group selected among halogens and a sulfonic group.

16. The oxygen reduction catalyst according to claim 6 characterized by comprising an organometallic polymer structure in which at least a part of hydrogen (H) included in the substituent according to claim 6 is substituted by a ligand comprising a heterocyclic 5-membered ring or a heterocyclic 6-membered ring containing at least not less than two elements selected from nitrogen (N), oxygen (O), sulfur (S), and selenium (Se), and derivatives thereof, or at least one ligand selected among an amino group, an imino group, a carboxyl group, a hydroxy group, oximes, ketones, an aldehyde group, thiols, phosphine, arsine, selenide, a thiocarboxyl group, a dithiocarboxyl group, and dithiocarbamate.

17. The oxygen reduction catalyst according to claim 7 characterized by comprising an organometallic polymer structure in which at least a part of hydrogen (H) included in the functional group according to claim 7 is substituted by a ligand comprising a heterocyclic 5-membered ring or a heterocyclic 6-membered ring containing at least not less than two elements selected from nitrogen (N), oxygen (O), sulfur (S), and selenium (Se), and derivatives thereof, or at least one ligand selected among an amino group, an imino group, a carboxyl group, a hydroxy group, oximes, ketones, an aldehyde group, thiols, phosphine, arsine, selenide, a thiocarboxyl group, a dithiocarboxyl group, and dithiocarbamate.
